(19) United States
(12) Patent Application Publication
(10) Pub. No.: US 2008/0125873 A1
(43) Pub. Date: May 29, 2008

(54) System And Method Of Configuring A Control System For A Plurality Of Devices

(75) Inventors: David Copplestone Payne, Virginia Water (GB); Noel Francois Leopold Bonne, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/814,494

(22) PCT Filed: Jan. 23, 2006
(86) PCT No.: PCT/IB06/50241

§ 371 Date: Jul. 23, 2007

(30) Foreign Application Priority Data
Jan. 24, 2005 (EP) 05100431.5

(51) Int. Cl. G05B 15/02

(52) U.S. Cl. 700/2

(57) ABSTRACT

In a method and system of configuring a control system for a plurality of devices (12) of different types, each device has at least one operating parameter. At least one operating parameter setting is stored in a memory for each device. The operating parameter setting depends on a use parameter. A set of devices is assigned to a first area (4, 6, 8, 10), and a use parameter is assigned to the first area. An operating parameter setting corresponding to the use parameter is selected for each device in the first area. A further use parameter is assigned to a plurality of areas (14) including the first area (4, 6, 8, 10). An operating parameter setting corresponding to said further use parameter is selected for at least one device in said plurality of areas.

### FIELD OF THE INVENTION

The present invention relates to a system and method of configuring a control system for a plurality of devices.

In the field of, for instance, building management systems, systems providing a (possibly at least partly centralized) control of artificial lighting, heating, cooling, air conditioning, access, background music, public addressing and the like are known. Devices being part of such systems may be individually controllable, either globally or locally, possibly with the aid of a variety of appropriate sensors. The control of such systems and the devices contained therein may be performed with one or more (possibly networked) computers and/or controllers communicating with each other in a suitable manner, or by built-in or hand-held actuating or control devices. Such systems may improve energy conservation by providing a combination of individual and central control of lighting levels or temperatures at one or more areas within a building, or may permit a temporary reduction of energy consumption on an effective basis in the event the energy supply system or the public utility is overloaded or limited in capacity. Further, such systems may provide enhanced user safety, user comfort, or user information.

### BACKGROUND OF THE INVENTION

In the configuration of building management systems, it is known to use a controller application computer program having suitable user interfaces, such as graphical user interfaces. In such user interfaces, an area (alternatively also referred to as a zone) in or outside a building may be represented on a display device based on imported building plans, and different devices such as sensors, switches, actuators, lights, ventilators, heaters and the like may be indicated to be present in the area, e.g. represented as icons at appropriate places, and to be connected to a (possibly networked) controller. With this information, the controller application computer program may, with the manual input of a user or automatically, generate a linking between the devices belonging to the same area, and may also generate a control program to be used for the controller controlling the devices, wherein operating parameters for the devices are set defining how each device responds to signals sent to it to provide the required mode of operation. This mode of operation may vary depending on the time of day, the occupancy of the area, the temperature or light level, or other requirements of use. The setting or settings of operating parameters for each of the devices of the same type are predetermined, to avoid having to set each operating parameter for each similar device separately. Instead, settings are taken from a default set of operating parameters. Thus, the configuration of the actual system may be performed without having to define the setting of each operating parameter of several similar devices individually. Some or all of the operating parameters of a device may be modified afterwards depending on the specific requirements for the area in which the device is to operate, or the specific purpose for which the area is used by the envisaged occupants.

In the prior art, a problem can be recognized in setting operating parameters for all devices in a building, containing a plurality of areas. This process is time-consuming, in particular for large multi-storey buildings. In addition, a significant level of technical expertise is required to define correct operating parameters for the different areas in the building under various conditions. Should errors be made in the operating parameter setting, or should a specific setting be omitted leaving inappropriate default operating parameters in the control program, then an incorrect functioning of the system will result. This condition will dissatisfy the building users, which will lead to complaints. Resetting the operating parameters of devices consumes time and money.

### SUMMARY OF THE INVENTION

In an embodiment, the present invention provides a system of configuring a control system for a plurality of devices of different types, each device having at least one operating parameter, the system comprising: a memory for storing at least one operating parameter setting for each device, the operating parameter setting depending on a use parameter; means for assigning a set of devices to a first area; means for assigning a use parameter to said first area; and means for selecting an operating parameter setting corresponding to said use parameter for each device in said first area, the system further comprising: means for assigning a further use parameter to a plurality of areas including said first area; and means for selecting an operating parameter setting corresponding to said further use parameter for at least one device in said plurality of areas.

In an embodiment, the present invention provides a method of configuring a control system for a plurality of devices of different types, each device having at least one operating parameter, the method comprising: storing at least one operating parameter setting for each device in a memory, the operating parameter setting depending on a use parameter; assigning a set of devices to a first area; assigning a use parameter to said first area; and selecting an operating parameter setting corresponding to said use parameter for each device in said first area, the method further comprising: assigning a further use parameter to a plurality of areas including said first area; and selecting an operating parameter setting corresponding to said further use parameter for at least one device in said plurality of areas.

According to the present invention, operating parameter settings which are associated with a set of devices of different types situated in a first area having a particular use, as indicated by a use parameter, now may be adapted automatically by selecting a further use parameter indicating a particular use of, or specific requirements for, the plurality of areas of which the first area forms part. Examples of areas in a building are a floor, a corridor, an entrance, a lobby, an elevator, a staircase, a cell office, a work island, a meeting room, a test area, etc. Examples of areas outside a building are a parking area, a storage area, a (part of a) road, etc. Generally, an area may be recognized from other areas where it has a distinctive feature or characteristic, or where the devices in it working together should be controlled or managed separately from devices in other areas.

According to the invention, should a particular use of the plurality of areas be required, then in a single operation the corresponding operating parameter settings of the devices present in said plurality of areas may be selected. It is to be noted that it may not be necessary to change the operating parameter settings of all devices in the plurality of areas as a result of the selection of the further use parameter. Some, but not all, operating parameter settings may remain unchanged despite the selection of the further use parameter.

As a result, the configuration process is speeded up, and the possibility of errors is reduced. The task of configuring may be performed by people having lower levels of skill.

Some or all of the operating parameters of a device may be modified afterwards depending on the specific requirements for the area or plurality of areas in which the device is to operate, or the specific purpose for which the area or plurality of areas is used by the envisaged occupants.

The system and method according to the invention may be implemented using a computer and a computer program made available in a suitable form, i.e. stored in a recording medium, stored in a memory, either locally or remotely, carried on a carrier signal, etc. A suitable workstation, like a desktop computer, a laptop computer, a palmtop computer or any other type of suitable computing device coupled, either wired or wirelessly, to a processor and a memory may be applied for the configuration according to the present invention.

### BRIEF DESCRIPTION OF THE DRAWING

The above and other aspects of the invention will be apparent from and elucidated with reference to the appended drawing illustrating aspects of the system and method according to the invention, wherein:

FIG. 1 shows a part of a plan of a building depicted on a screen of a display device.

### DESCRIPTION OF EMBODIMENTS

Systems for controlling devices are configured using a computer system. In a configuration tool (application program) implemented on the computer system, objects representing the devices to be controlled have been defined and stored in a database. Further, one or more operating parameters of each device, or object representing the device, have been defined and stored in a database, linked to the associated device or devices. The operating parameter(s) for a specific kind of device may be predefined as default operating parameter(s).

While taking the configuration of a building management system as an example, a plan of a (part of a) building (e.g. commercial building, residential building, hotel, restaurant, etc.) comprising a plurality of areas is depicted on a display device.

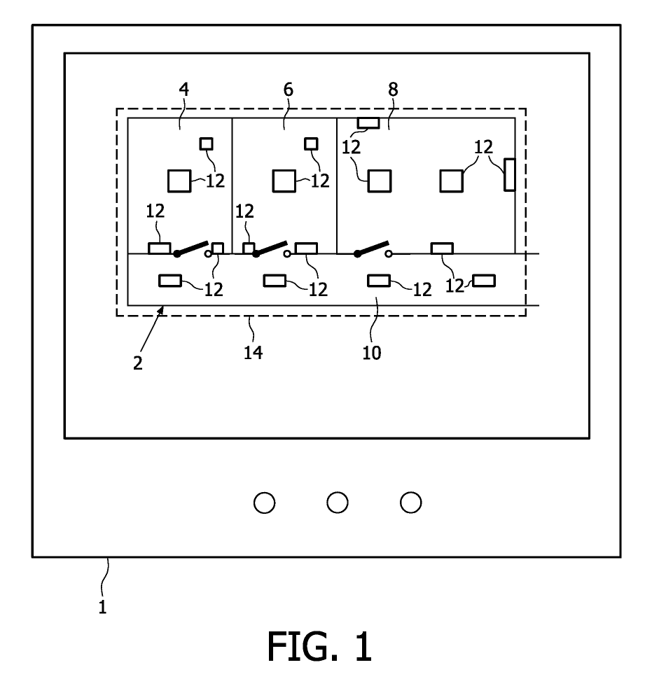

FIG. 1 shows a plan of a floor of a building, as may be depicted on a screen of a display device 1 of a computer system by a configuration tool having a graphical user interface. The plan shows a floor 2 having areas or rooms 4, 6 and 8, and a corridor 10 to which the rooms 4, 6 and 8 open out. A user, using a computer mouse or any other input device, may position objects 12 representing devices in any of rooms 4, 6 or 8 in any suitable way, such as by selection from pull-down menus displayable on the screen. Examples of objects representing devices are a sensor (such as an occupancy sensor, a light level sensor, a temperature sensor or a smoke alarm), an infrared transceiver, a switch, an actuator, a lamp, a luminaire, a ventilating device, a heating device, a cooling device, and the like.

In operation, some of the devices (represented by the objects), such as sensors, supply only output signals representing a physical condition in the associated area. Other devices, such as actuators, accept only input signals, and still other devices, such as infrared transceivers, both accept input signals and supply output signals. These input and output signals are processed by a controller to which the devices represented by the objects 12 are to be connected, either hard-wired or wirelessly. The configuration tool comprises one or more operating parameters linked to each device, and defining how the device responds to a signal sent to it according to a functional requirement for the area in which the device represented by the object 12 concerned is situated.

The configuration tool is adapted to associate a first set of devices represented by objects 12 and situated in a first area, such as one of the rooms 4, 6, 8 or the corridor 10, with each other, and to select the setting of one or more operating parameters for each device of the first set of devices in the same area such that an appropriate common operation of the first set of devices (also to be referred to as a functional group of devices) is achieved. In this respect, an initial default setting of the operating parameters of devices of different types in one area is determined by the configuration tool containing default operating parameter settings according to application types for the occupied area, e.g. “office”, “conference room”, “pantry”, “corridor”, “toilet”, “bathroom”, “dining area”, “bedroom”, and the like. For the configuration tool, an application type is indicated by a use parameter to be input. Thus, by assigning a use parameter to an area, the configuration tool will select an appropriate setting of the operating parameter(s) for the functional group of devices in the area.

In addition, the configuration tool is adapted to associate at least one of the first areas 4, 6, 8 or 10 with other areas to define (select) a plurality (i.e. two or more) of areas 14 (indicated by a dashed line), and to select the setting of one or more operating parameters for each device represented by an object 12 or a selection thereof in the plurality of areas 14 such that an appropriate common operation (as indicated by a further use parameter) of a group of devices represented by objects 12 (also to be referred to as a further functional group of devices) in the plurality of areas 14 is achieved. In turn, the plurality of areas 14 may be associated with one or more other (sets of) areas to define still further functional groups of devices, etc. In this respect, a setting of the operating parameters of devices in a plurality of areas may be determined by the configuration tool containing default operating parameter settings according to further use parameters for the plurality of areas, e.g. “open plan”, “floor”, “elevator”, “staircase” and the like.

From the above, it follows that a device in an area may have its operating parameters initially determined by a use parameter and one or more further use parameters. In addition, for a specific device, operating parameters may be modified afterwards depending on specific requirements.

As an example, operating parameters may be set as follows. Each room 4, 6 or 8 may have an occupancy sensor which, when activated, will turn on the light in the room 4, 6 or 8, respectively. If no occupant is detected in a room 4, 6 or 8, the light will be turned off in the respective room 4, 6 or 8 after a predetermined time period. The light in the corridor 10 may be always on. When configuring such a system, in the configuration tool appropriate operating parameters settings may be stored for devices 12 being situated in an area to be designated as “office” by a corresponding use parameter. At least partly different operating parameter settings may be stored for devices 12 being situated in an area to be designated as “conference room” by a corresponding use parameter. Again, other operating parameter settings are stored for devices 12 being situated in the corridor 10. By simply designating the rooms 4 and 6 each as “office”, operating parameter settings for the devices 12 of different type in the rooms 4 and 6 are selected automatically by the configuration tool. Similarly, by designating the room 8 as “conference room”, operating parameters settings for the devices 12 of different types in the room 8 are selected automatically by the configuration tool.

Now, by designating the plurality of areas 14 comprising the areas 4, 6, 8 and 10 as having a function “floor”, operating parameter settings for the devices 12 of different type in the rooms 4, 6, 8 and in the corridor 10 are selected/adapted automatically by the configuration tool according to a further use parameter in accordance with the function “floor”: a light in the corridor 10 will be on as long as an occupant is detected in any of the rooms 4, 6 or 8. When no occupant is detected in all of the rooms 4, 6 and 8, the light in the corridor will be dimmed to a predetermined level after a predetermined time. Thus, the light in the corridor 10, having a basic operating parameter indicating that is should be always on when the use parameter designates the function “corridor”, now has its operating parameter adapted, indicating an additional dimming action according to the further use parameter “floor”.

Once the device operating parameter configuration has been performed and an associated physical network (which may include computers, communication channels, routers, controllers, power supplies, etc.) has been devised, the network may be automatically configured using the configuration made by the configuration tool.

In view of the above, the invention provides a system and method for a simple configuration of a control system for a plurality of devices in an area having a specific use, and in a plurality of areas having a specific use.

It is noted that the present invention is not limited to application in a building. Its use may extend to areas associated with the building, like parking garages, parking lots, roads or parts thereof, and any other areas where devices need to be managed to obtain a desired environment.

It is further noted that in the appended claims, the term “comprising” does not exclude other elements or steps, “a” and “an” does not exclude a plurality. A single processor or multiple processors may fulfill the functions of several means recited in the claims.

1. A system of configuring a control system for a plurality of devices (12) of different types, each device having at least one operating parameter, the system comprising:
a memory for storing at least one operating parameter setting for each device, the operating parameter setting depending on a use parameter;
means for assigning a set of devices to a first area (4, 6, 8, 10);
means for assigning a use parameter to said first area; and
means for selecting an operating parameter setting corresponding to said use parameter for each device in said first area,
the system further comprising:
means for assigning a further use parameter to a plurality of areas (14) including said first area (4, 6, 8, 10); and
means for selecting an operating parameter setting corresponding to said further use parameter for at least one device in said plurality of areas.

2. The system of claim 1, further comprising a controller for processing input signals and output signals of said plurality of devices for controlling an operation of each device according to said selected operating parameter setting corresponding to said use parameter or said further use parameter.

3. The system of claim 1, further comprising at least one processor.

4. A method of configuring a control system for a plurality of devices (12) of different types, each device having at least one operating parameter, the method comprising:
storing at least one operating parameter setting for each device in a memory, the operating parameter setting depending on a use parameter;
assigning a set of devices to a first area (4, 6, 8, 10);
assigning a use parameter to said first area; and
selecting an operating parameter setting corresponding to said use parameter for each device in said first area,
the method further comprising:
assigning a further use parameter to a plurality of areas (14) including said first area (4, 6, 8, 10); and
selecting an operating parameter setting corresponding to said further use parameter for at least one device in said plurality of areas.

5. The method of claim 4, further comprising:
processing input signals and output signals of said plurality of devices (12) for controlling an operation of each device according to said selected operating parameter setting corresponding to said use parameter or said further use parameter.

6. A computer program comprising program instructions for carrying out the method according to claim 4.

7. A computer program according to claim 6 stored in a recording medium.

8. A computer program according to claim 6 stored in a memory.

9. A computer program according to claim 6 carried on a carrier signal.

10. A recording medium storing a computer program comprising program instructions for carrying out the method according to claim 4.

11. Use of a workstation for carrying out the method according to claim 4.
